(19) United States
(12) Patent Application Publication
(10) Pub. No.: US 2024/0419927 A1
(43) Pub. Date: Dec. 19, 2024

(54) CONTRASTIVE LEARNING WITH ADVERSARIAL DATA FOR ROBUST SPEECH TRANSLATION

(71) Applicant: Zoom Video Communications, Inc., San Jose, CA (US)

(72) Inventors: Ravi Agrawal, San Francisco, CA (US); Shamil Chollampatt Muhammed Ashraf, Singapore (SG); Sathish Reddy Indurthi, Cupertino, CA (US); Marco Turchi, Pergine Valsugana (IT)

(73) Assignee: Zoom Video Communications, Inc., San Jose, CA (US)

(21) Appl. No.: 18/627,098

(22) Filed: Apr. 4, 2024

Related U.S. Application Data
(60) Provisional application No. 63/521,253, filed on Jun. 15, 2023.

(51) Int. Cl. G06F 40/58; G06F 40/284

(52) U.S. Cl. CPC G06F 40/58; G06F 40/284

(57) ABSTRACT

Systems and methods are disclosed for contrastive learning with adversarial data for robust speech translation. For example, a method may include inputting a speech signal to an automatic speech recognition model to obtain a transcript hypothesis including a first sequence of tokens, wherein the speech signal is associated with a golden transcript including a second sequence of tokens; inputting the first sequence of tokens to an encoder of a neural machine translation model to obtain a first sentence representation; inputting the second sequence of tokens to the encoder of the neural machine translation model to obtain a second sentence representation; determining a contrastive loss function based on the first sentence representation and the second sentence representation; and training the encoder of the neural machine translation model based on the contrastive loss function.

### CROSS-REFERENCE TO RELATED APPLICATIONS

This application claims the benefit of U.S. Provisional Application No. 63/521,253, filed on Jun. 15, 2023, which is incorporated herein by reference in its entirety.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a flowchart of an example of a technique for contrastive learning with adversarial data for robust speech translation.

FIG. 5 is a flowchart of an example of a technique for iteratively switching between batches of training an encoder of a neural machine translation model based on transcript hypotheses from an automatic speech recognition model and corresponding golden transcripts using a contrastive loss function, and batches of training the neural machine translation model based on source-target text translation pairs.

FIG. 6 is a block diagram of an example of a system for contrastive learning with adversarial data for robust speech translation.

### DETAILED DESCRIPTION

A cascaded approach may be used for speech translation (ST). This approach consists of an automatic speech recognition (ASR) model and a machine translation (MT) model that are used in a pipeline to translate speech in one language to text in another language. MT models are often trained on well-formed text and therefore lack robustness while translating noisy ASR outputs in the cascaded approach, degrading the overall translation quality significantly. In some implementations described herein, this robustness problem in downstream MT is addressed models by forcing the MT encoder to bring the representations of a noisy input closer to its clean version in the semantic space. This may be achieved by introducing a contrastive learning method that leverages adversarial examples in the form of ASR outputs paired with their corresponding human transcripts to optimize the network parameters. In addition, a curriculum learning strategy may then be used to stabilize the training by alternating the standard MT log likelihood loss and the contrastive losses. In some implementations, this approach may achieve significant gains of up to 3 BLEU scores in English-German and English-French speech translation over conventional ST systems without hurting the translation quality on clean text.

Neural machine translation (NMT) has made significant advancements over the past several years with claims of achieving human parity and super-human performance. However, despite making significant progress in quality and coverage, NMT models have been identified to lack robustness in dealing with noisy inputs. Robustness is especially important in cascaded speech translation (ST) systems, where an NMT model works on the output of the upstream automatic speech recognition (ASR) system. In this scenario, significant MT performance degradation has been measured due to i) error propagation from the ASR and ii) the mismatch between training-testing condition as the NMT model is typically trained on well-formed text making it weak in dealing with noisy inputs. To address the robustness issue, there has been a shift towards building end-to-end ST models. However, due to the lack of speech translation datasets in many languages and the inflexibility to independently optimize ASR and MT systems, cascaded systems continue to be a dominant approach.

Another line of research has tried to tackle robustness in NMT models independently by (1) synthetic noise injection, including mimicking ASR errors for the ST task or (2) by adding noise to the continuous-space representations learned by the NMT model. Some of the synthetic noise injection methods replace words with probable words from ASR confusion lattices but fail to consider the full context and to realistically replicate ASR errors, like the phrase-level errors and segmentation errors that ASR models often make (see Table 1).

TABLE 1
Example human transcript and OpenAI Whisper ASR output from
the MuST-C En-De devset. The underlined text indicates erroneous
phrases and italicized indicates punctuation errors.

Human Transcript: I'm not sure that's wise, given the importance of the
problem, but there's now the geoengineering discussion about: Should that
be in the back pocket in case things happen faster, or this innovation
goes a lot slower than we expect?
ASR Output: I'm not sure that's why it's given the importance of the
problem. But now that the geoengineering discussion about should that be
in the back pocket in case things happen faster or this innovation goes a
lot slower than we expect.

On the other hand, the latter approaches pre-dominantly generate arbitrary or random error distributions and overlook the real-world error signals from the actual upstream model.

To address the robustness problem, particularly in the context of cascaded ST, some implementations described herein may combine the best of the two approaches. This combination may be implemented by training the NMT model with adversarial examples generated from the ASR outputs and encouraging the encoder representations of both the ASR outputs and their corresponding human transcripts to be closer to each other. Contrastive learning may be used, in addition to the standard log-likelihood NMT training, and through curriculum learning by pretraining on log-likelihood loss followed by iteratively alternating between the two objectives. The disclosed methods may achieve to significant improvements in the ST task on two language pairs (e.g., English-German and English-French) without hurting the performance on MT of well-formed texts. This approach may also eliminate the need for any end-to-end ST data (i.e., speech aligned with their transcription and translation), making it easier to apply to a wider range of language pairs compared to the end-to-end approaches.

In some implementations, the NMT model may be a transformer model with several encoder and decoder layers, with self-attention modules within each block and a cross-attention module to link the encoder and decoder components. Training the network parameters Θ is done by minimizing the mean negative log-likelihood over a batch of n source-target text translation pairs (X, Y)=(x⁽¹⁾, y⁽¹⁾, . . . , (x⁽ⁿ⁾, y⁽ⁿ⁾). This objective encourages producing a target sentence y with a sequence of tokens y₁, y₂, . . . , y_{|y|} given the source sentence x with sequence of tokens x₁, x₂, . . . , x_{|x|.}

$${ℒ}_{NMT} = - {\sum }_{i = 1}^{n} {\sum }_{j = 1}^{\vert {y}^{( i )} \vert} log P ( {y}_{j}^{( i )} \vert {x}^{( i )} , {y}_{< j}^{( i )} , Θ )$$

To improve the robustness of the NMT model on noisy ASR outputs for cascaded speech translation, a contrastive learning may be used that is aimed to bring the representations of a noisy sentence generated by the upstream ASR closer to its clean version (the human transcript for the same audio) in the semantic space modeled by the NMT encoder.

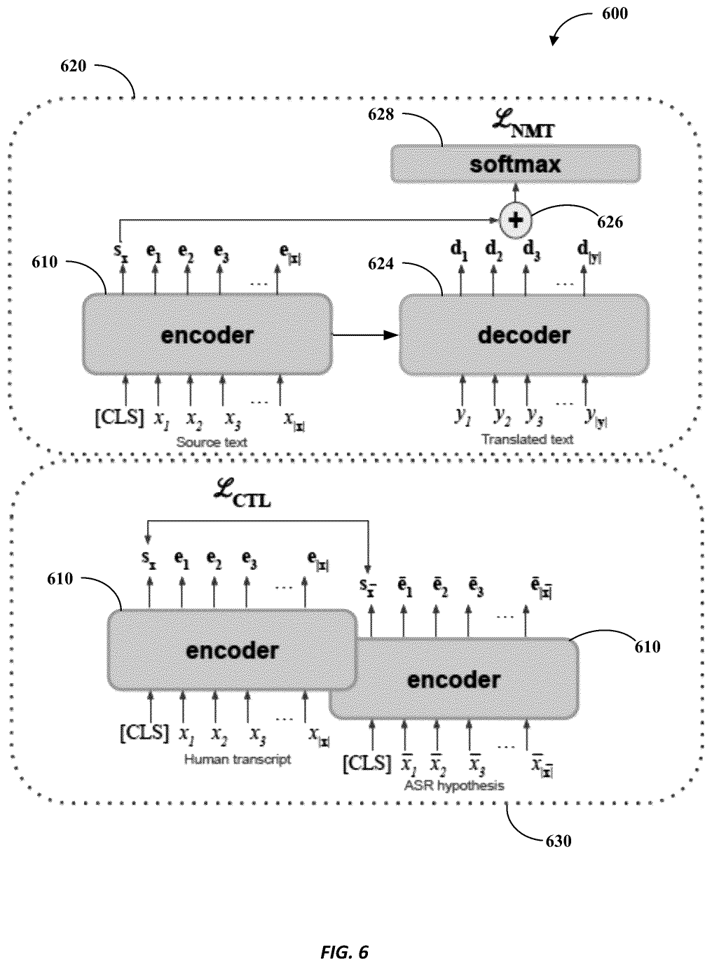

To get the encoder sentence representations efficiently for contrastive learning, a contrastive learning token ([CLS] token) may be prepended to the input sentences. The encoder output corresponding to the [CLS] token will be used as the sentence representation sₓ, which may also get added to each of the decoder outputs before softmax (see, e.g., FIG. 6).

For example, contrastive learning may use speech transcription corpora (i.e., speech paired with human transcripts). The speech input may be passed through the upstream ASR model to obtain the ASR outputs. Given the noisy ASR output x̅ paired with its corresponding clean human transcript x, we minimize the contrastive objective [symbol] , which is an average of two symmetric sentence-level contrastive loss functions.

Given a batch of n examples (X, X̅)={(x⁽¹⁾, x̅⁽¹⁾), . . . , (x⁽ⁿ⁾, x̅⁽ⁿ⁾)}

$${ℒ}_{CTL} = \frac{1}{2 n} {\sum }_{i = 1}^{n} ( {ℒ}_{c} ( {x}^{( i )} ) + {ℒ}_{c} ( {\overline{x}}^{( i )} ) ) \\ Where \\ {ℒ}_{c} ( x ) = - log \frac{exp ( s ( {s}_{x} , {s}_{\overline{x}} ) )}{exp ( s ( {s}_{x} , {s}_{\overline{x}} ) ) + {\sum }_{{x}^{′}} exp ( s ( {s}_{x} , {\hat{s}}_{{x}^{′}} ) )} \qquad Equation 1$$

s(u, v) denotes the cosine similarity between two vectors u and v. ŝ_{x′} represents a negative example constructed for every other sentence x′ in the batch. Given x′ ∈ (X ∪X)\{x, x̅} and its sentence embedding s_{x′}

$${\hat{s}}_{{x}^{′}} = \{ \begin{matrix}{s}_{x} + {λ}_{x} ( {s}_{{x}^{′}} - {s}_{x} ) & if , {d}_{x}^{+} < {d}_{x}^{-} \\ {s}_{{x}^{′}} & otherwise\end{matrix} \qquad Equation 2$$

Where dₓ^{+=∥s}ₓ+s_{x̅}∥₂, dₓ⁻=∥sₓ−s_{x′}∥₂, and

$${λ}_{x} = \frac{{d}_{x}^{+}}{{d}_{x}^{-}} .$$

The above linear interpolation in Equation 2 with exponentially decaying λₓ is implemented to increase the hardness of negative examples by not selecting uninformative negative examples as training progresses. [symbol] (x̅) follows similar formulation as [symbol] (x) with x replaced by x̅, and vice versa. To stabilize the NMT parameters before applying contrastive learning, curriculum learning may also be used. The model may be first pre-trained with NMT loss [symbol] only for the first N batches, followed by iteratively training alternate batches with [symbol] and [symbol] losses, respectively, until convergence. With this model and training regime, which alternates between training with translation and speech recognition datasets independently, robust NMT models for cascaded ST may be built without any requirement for speech translation data.

For example, this approach may be implemented using Fairseq (available at https://github.com/facebookresearch/fairseq). For example, systems described herein may be implemented on A100 GPU, and gradient accumulation and batch size may be set to 8 iterations and 8 k tokens. For CLAD-ST, an NMT model may be pretrained for the first 50,000 batches for NMT loss in the curriculum. For evaluation, the beam size and length penalty may be set to 4 and 0.6.

Some implementations may provide advantages over conventional systems for speech translation. For example, some implementations, may improve the robustness of MT to ASR outputs using contrastive learning to bring the representations of clean and noisy examples closer in the semantic space. This approach does not require a speech translation corpus. In some implementations, the translation accuracy on noisy ASR outputs may be significantly improved without degrading translation accuracy on clean text. This approach is scalable to better-quality ASR models in the cascade other than the one used during training. This approach may be applicable beyond the context of speech translation alone, such as translating user-generated chat text or non-native text if paired noisy-clean data is available.

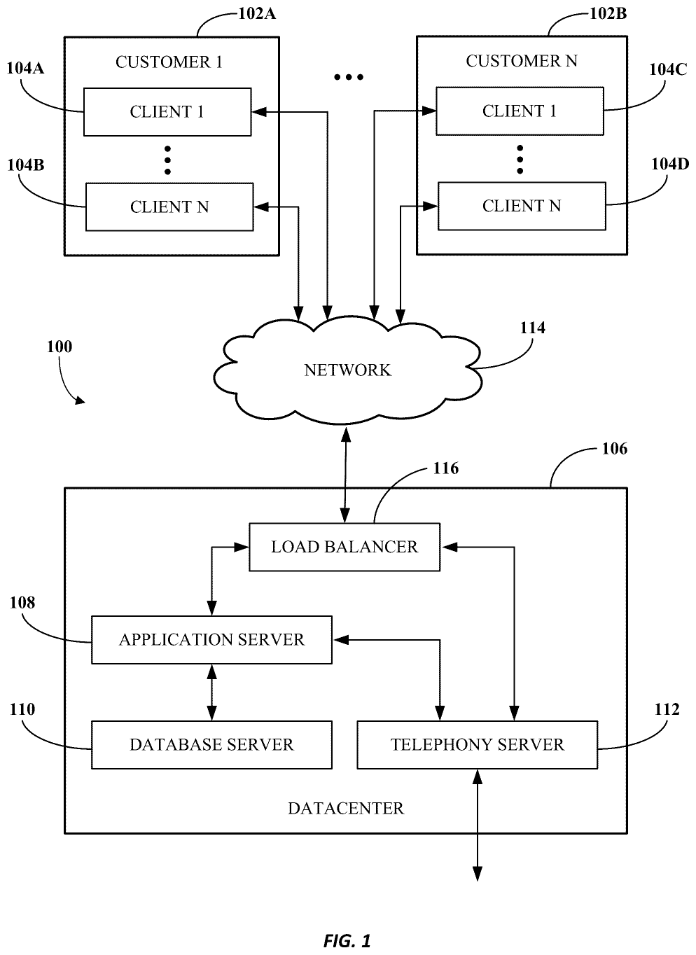

To describe some implementations in greater detail, reference is first made to examples of hardware and software structures used to implement robust speech translation with an automatic speech recognition model cascaded with a neural machine translation model. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. Datacenters may be spread across various geographical locations. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application servers 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

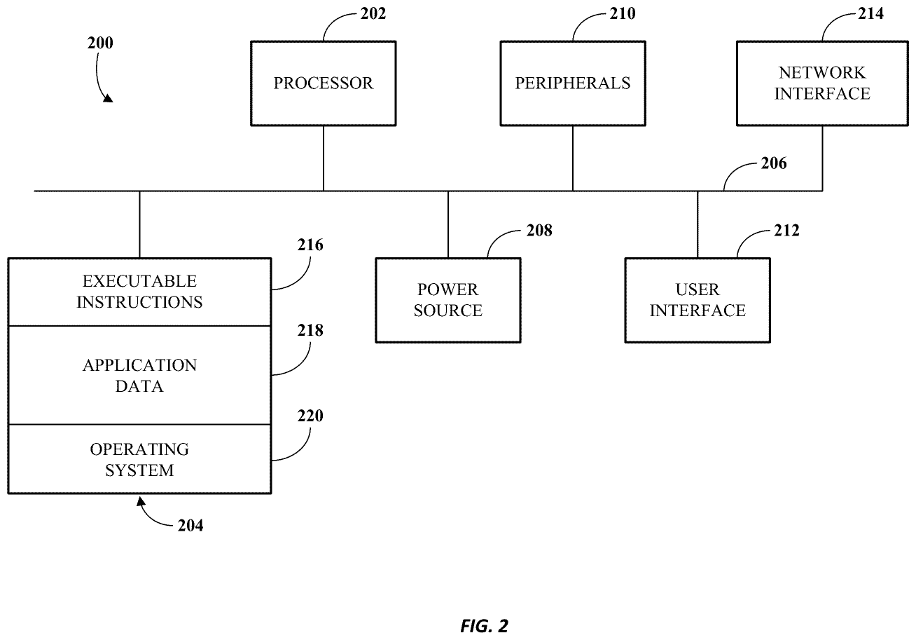

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

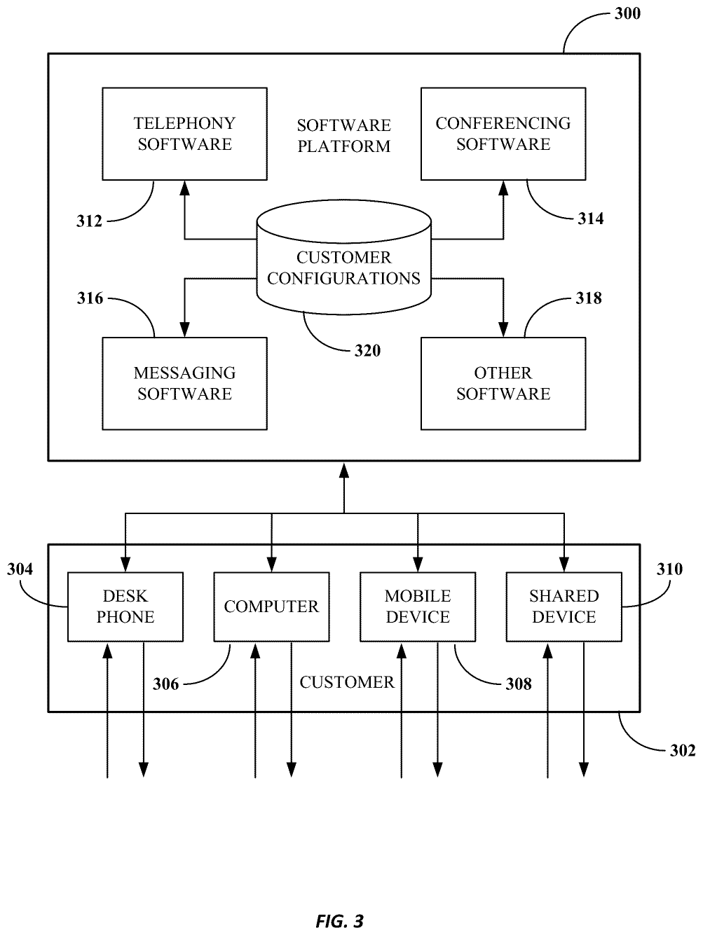

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software for robust speech translation audio data (e.g., calls or conference audio) in the software platform 300.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

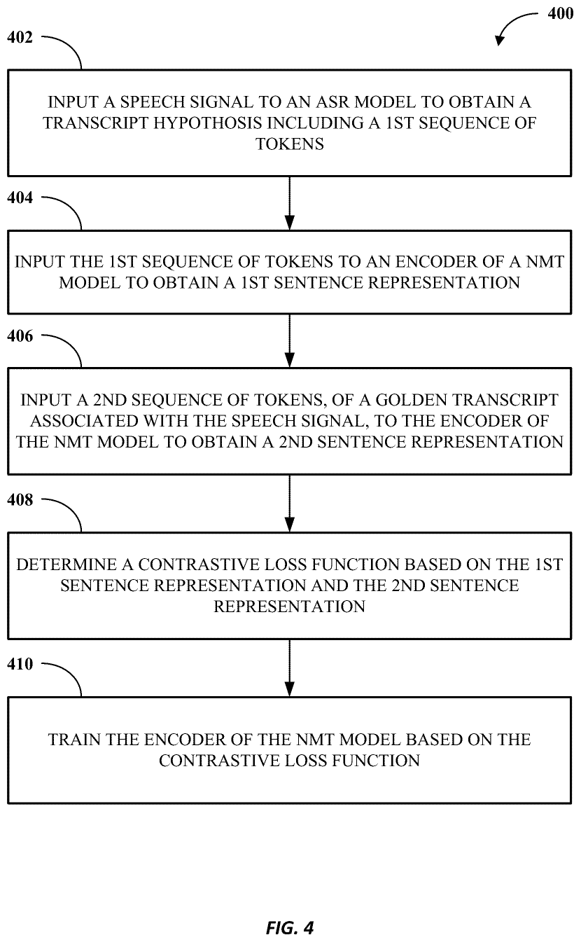

FIG. 4 is a flowchart of an example of a technique 400 for contrastive learning with adversarial data for robust speech translation. The technique 400 can be executed using computing devices, such as the systems, hardware, and software described with respect to FIGS. 1-3 and FIG. 6. The technique 400 can be performed, for example, by executing a machine-readable program or other computer-executable instructions, such as routines, instructions, programs, or other code. The steps, or operations, of the technique 400 or another technique, method, process, or algorithm described in connection with the implementations disclosed herein can be implemented directly in hardware, firmware, software executed by hardware, circuitry, or a combination thereof.

For simplicity of explanation, the technique 400 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 402, the technique 400 includes inputting a speech signal to an automatic speech recognition model to obtain a transcript hypothesis including a first sequence of tokens, wherein the speech signal is associated with a golden transcript including a second sequence of tokens. For example, the speech signal may be an audio recording of human speech sampled at a suitable rate (e.g., 8 kHz, 44.1 kHz, 48 kHz, 96 kHz, or 192 kHz). For example, the automatic speech recognition model may be the automatic speech recognition model may be an Open AI Whisper ASR. For example, the golden transcript may be generated by a human listening to speech signal. For example, the golden transcript may be generated, based on the speech signal, using a second automatic speech recognition model with high complexity or quality than the automatic speech recognition model to be trained for deployment in the field as part of cascaded speech translation system. For example, the tokens may correspond to words spoken in the speech signal.

At 404, the technique 400 includes inputting the first sequence of tokens to an encoder of a neural machine translation model to obtain a first sentence representation. For example, the neural machine translation model may be a transformer model with several encoder and decoder layers, with self-attention modules within each block and a cross-attention module to link the encoder and decoder components. For example, the first sentence representation may be a vector in a semantic space modeled by the encoder of the neural machine translation model. In some implementations, a special contrastive loss token is appended to the first sequence of tokens when it is input to the encoder of the neural machine translation model to obtain the first sentence representation. For example, the encoder output corresponding to the special contrastive loss token ([CLS] token) may be used as the first sentence representation.

At 406, the technique 400 includes inputting the second sequence of tokens to the encoder of the neural machine translation model to obtain a second sentence representation.

At 408, the technique 400 includes determining a contrastive loss function based on the first sentence representation and the second sentence representation. For example, determining the contrastive loss function may include determining a distance (e.g., a cosine distance) between the first sentence representation and the second sentence representation. In some implementations, determining the contrastive loss function includes determining a distance between the first sentence representation and a negative example that is constructed from other noisy and clean sentences in a batch of speech signal training data. In some implementations, determining the contrastive loss function includes determining a distance between the second sentence representation and a negative example that is constructed from other noisy and clean sentences in a batch of speech signal training data. For example, the contrastive loss function may be determined in accordance with Equation 1 and Equation 2 above.

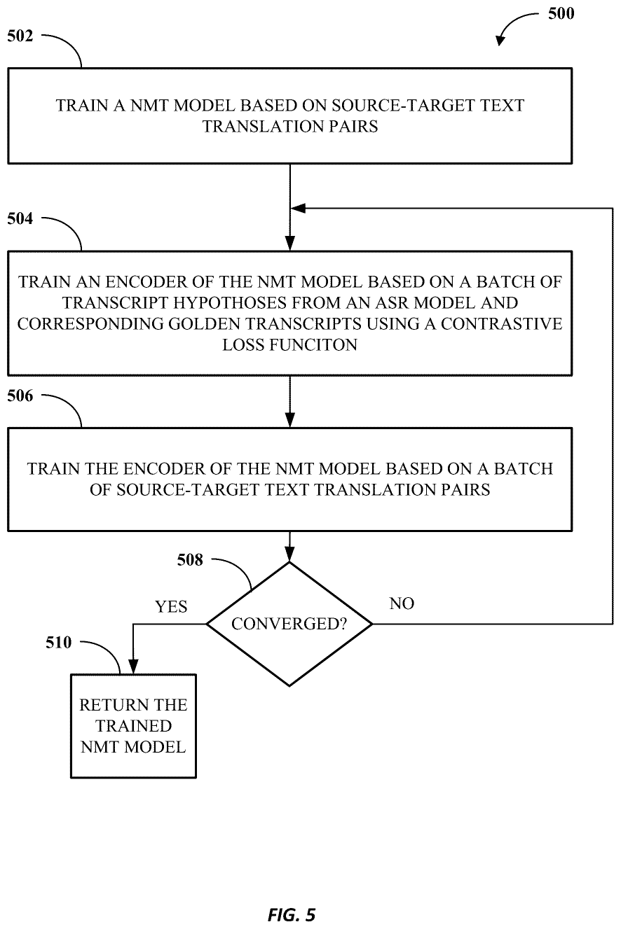

At 410, the technique 400 includes training the encoder of the neural machine translation model based on the contrastive loss function. For example, the encoder of the neural machine translation model may be trained using gradient descent method with the contrastive loss function as the cost function. The encoder of the neural machine translation model may be trained using a curriculum learning strategy to stabilize the training by alternating standard MT log likelihood loss and the contrastive losses. In some implementations, the encoder of the neural machine translation model is also trained based on source-target text translation pairs. In some implementations, training the encoder of the neural machine translation model includes iteratively switching between batches of training the encoder of the neural machine translation model based on transcript hypotheses from the automatic speech recognition model and corresponding golden transcripts using the contrastive loss function, and batches of training the neural machine translation model based on source-target text translation pairs. For example, raining the encoder of the neural machine translation model may include implementing the technique 500 of FIG. 5.

FIG. 5 is a flowchart of an example of a technique for iteratively switching between batches of training an encoder of a neural machine translation model based on transcript hypotheses from an automatic speech recognition model and corresponding golden transcripts using a contrastive loss function, and batches of training the neural machine translation model based on source-target text translation pairs. The technique 500 can be executed using computing devices, such as the systems, hardware, and software described with respect to FIGS. 1-3 and FIG. 6. The technique 500 can be performed, for example, by executing a machine-readable program or other computer-executable instructions, such as routines, instructions, programs, or other code. The steps, or operations, of the technique 500 or another technique, method, process, or algorithm described in connection with the implementations disclosed herein can be implemented directly in hardware, firmware, software executed by hardware, circuitry, or a combination thereof.

For simplicity of explanation, the technique 500 is depicted and described herein as a series of steps or operations. However, the steps or operations in accordance with this disclosure can occur in various orders and/or concurrently.

Additionally, other steps or operations not presented and described herein may be used. Furthermore, not all illustrated steps or operations may be required to implement a technique in accordance with the disclosed subject matter.

At 502, the technique 500 includes training the neural machine translation model based on source-target text translation pairs. For example, the encoder of the neural machine translation model may be trained by minimizing the mean negative log-likelihood over a batch of n source-target text translation pairs.

For example, the [symbol] may be used as a loss function for training the neural machine translation model.

At 504, the technique 500 includes training an encoder of the neural machine translation model based on a batch of transcript hypotheses from the automatic speech recognition model and corresponding golden transcripts using the contrastive loss function.

At 506, the technique 500 includes training an encoder of the neural machine translation model based on a batch of source-target text translation pairs.

At 508, the technique 500 includes checking whether the model parameters of the encoder of the neural machine translation model have converged. For example, a distance metric for the model parameters of the encoder between iterations may be compared to threshold. When the change in the model parameters drops below the threshold, the model parameters may be determined to have converged. In some implementations, an average loss function value over training examples may be compared between iterations to assess whether the model parameters have converged. If the model parameters of the encoder of the neural machine translation model have not converged, then the iterative training continues at step 504. If the model parameters of the encoder of the neural machine translation model have converged, then the training is ended and the trained neural machine translation model is returned, at step 510, for use in an inference phase.

FIG. 6 is a block diagram of an example of a system 600 for contrastive learning with adversarial data for robust speech translation. The system 600 trains an encoder 610 of a neural machine translation model in two ways. In a first phase of training 620, the encoder 610 is trained as part of the larger neural machine translation model, including a decoder 624 an adder 626 and a softmax module 628, which can be used to determine a loss function (e.g., the [symbol] ) for training based on a training corpus including source-target text translation pairs. Source text is input to the encoder 610 while corresponding translated text is input to the decoder 624, the resulting representations of the source text and the translated text in a semantic space may be summed at the adder 626, and the sum may be passed into the softmax module 628 to determine the loss function at the output of softmax module 628.

In a second phase of training 630, the encoder 610 is trained individually using a contrastive learning approach. A special [CLS] token is prepended to a human transcript and also to an ASR hypothesis that then input to the encoder 610 to obtain representations of these sequences of tokens in a semantic space of the encoder 610. In particular, a sentence representation of the ASR hypothesis is determined corresponding to the [CLS] token and a sentence representation of the human transcript is determined corresponding to the [CLS] token. These sentence representation in the semantic space are then compared to be determine contrastive loss function (e.g., [symbol] ) that can be used to update (e.g., using a back propagation algorithm) the parameters of the encoder 610. For example, the contrastive loss function may be determined using Equation 1 and Equation 2 above.

In some implementations, a curriculum learning strategy may be used to stabilize the training by alternating between the first phase of training 620 and the second phase of training 630.

One aspect of this disclosure is a method including inputting a speech signal to an automatic speech recognition model to obtain a transcript hypothesis including a first sequence of tokens, wherein the speech signal is associated with a golden transcript including a second sequence of tokens; inputting the first sequence of tokens to an encoder of a neural machine translation model to obtain a first sentence representation; inputting the second sequence of tokens to the encoder of the neural machine translation model to obtain a second sentence representation; determining a contrastive loss function based on the first sentence representation and the second sentence representation; and training the encoder of the neural machine translation model based on the contrastive loss function. In this aspect, the method may include training the neural machine translation model based on source-target text translation pairs. In this aspect, the method may include iteratively switching between batches of training the encoder of the neural machine translation model based on transcript hypotheses from the automatic speech recognition model and corresponding golden transcripts using the contrastive loss function, and batches of training the neural machine translation model based on source-target text translation pairs. In this aspect, a special contrastive loss token may be appended to the first sequence of tokens when it is input to the encoder of the neural machine translation model to obtain the first sentence representation. In this aspect, determining the contrastive loss function may include determining a distance between the first sentence representation and the second sentence representation. In this aspect, determining the contrastive loss function may include determining a distance between the first sentence representation and a negative example that is constructed from other noisy and clean sentences in a batch of speech signal training data. In this aspect, determining the contrastive loss function may include determining a distance between the second sentence representation and a negative example that is constructed from other noisy and clean sentences in a batch of speech signal training data. For example, this aspect could be implemented using other software 318 running on the application server 108.

One aspect of this disclosure is a system, including a processor and a memory, wherein the memory stores instructions executable by the processor to input a speech signal to an automatic speech recognition model to obtain a transcript hypothesis including a first sequence of tokens, wherein the speech signal is associated with a golden transcript including a second sequence of tokens; input the first sequence of tokens to an encoder of a neural machine translation model to obtain a first sentence representation; input the second sequence of tokens to the encoder of the neural machine translation model to obtain a second sentence representation; determine a contrastive loss function based on the first sentence representation and the second sentence representation; and train the encoder of the neural machine translation model based on the contrastive loss function. In this aspect, the memory may store instructions executable by the processor to train the neural machine translation model based on source-target text translation pairs. In this aspect, the memory may store instructions executable by the processor to iteratively switch between batches of training the encoder of the neural machine translation model based on transcript hypotheses from the automatic speech recognition model and corresponding golden transcripts using the contrastive loss function, and batches of training the neural machine translation model based on source-target text translation pairs. In this aspect, a special contrastive loss token may be appended to the first sequence of tokens when it is input to the encoder of the neural machine translation model to obtain the first sentence representation. In this aspect, the memory may store instructions executable by the processor to determine a distance between the first sentence representation and the second sentence representation. In this aspect, the memory may store instructions executable by the processor to determine a distance between the first sentence representation and a negative example that is constructed from other noisy and clean sentences in a batch of speech signal training data. In this aspect, the memory may store instructions executable by the processor to determine a distance between the second sentence representation and a negative example that is constructed from other noisy and clean sentences in a batch of speech signal training data. For example, this aspect could include the processor 202 and the memory 204, which may be components of the application server 108.

One aspect of this disclosure is a non-transitory computer-readable storage medium, comprising executable instructions that, when executed by a processor, facilitate performance of operations, including inputting a speech signal to an automatic speech recognition model to obtain a transcript hypothesis including a first sequence of tokens, wherein the speech signal is associated with a golden transcript including a second sequence of tokens; inputting the first sequence of tokens to an encoder of a neural machine translation model to obtain a first sentence representation; inputting the second sequence of tokens to the encoder of the neural machine translation model to obtain a second sentence representation; determining a contrastive loss function based on the first sentence representation and the second sentence representation; and training the encoder of the neural machine translation model based on the contrastive loss function. In this aspect, the operations may include training the neural machine translation model based on source-target text translation pairs. In this aspect, the operations may include iteratively switching between batches of training the encoder of the neural machine translation model based on transcript hypotheses from the automatic speech recognition model and corresponding golden transcripts using the contrastive loss function, and batches of training the neural machine translation model based on source-target text translation pairs. In this aspect, a special contrastive loss token may be appended to the first sequence of tokens when it is input to the encoder of the neural machine translation model to obtain the first sentence representation. In this aspect, determining the contrastive loss function may include determining a distance between the first sentence representation and the second sentence representation. In this aspect, determining the contrastive loss function may include determining a distance between the first sentence representation and a negative example that is constructed from other noisy and clean sentences in a batch of speech signal training data. In this aspect, determining the contrastive loss function may include determining a distance between the second sentence representation and a negative example that is constructed from other noisy and clean sentences in a batch of speech signal training data. For example, this aspect could include other software 318 accessed by the application server 108.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

That which is claimed is:

1. A method comprising:
inputting a speech signal to an automatic speech recognition model to obtain a transcript hypothesis including a first sequence of tokens, wherein the speech signal is associated with a golden transcript including a second sequence of tokens;
inputting the first sequence of tokens to an encoder of a neural machine translation model to obtain a first sentence representation;
inputting the second sequence of tokens to the encoder of the neural machine translation model to obtain a second sentence representation;
determining a contrastive loss function based on the first sentence representation and the second sentence representation; and
training the encoder of the neural machine translation model based on the contrastive loss function.

2. The method of claim 1, comprising:
training the neural machine translation model based on source-target text translation pairs.

3. The method of claim 1, comprising:
iteratively switching between batches of training the encoder of the neural machine translation model based on transcript hypotheses from the automatic speech recognition model and corresponding golden transcripts using the contrastive loss function, and batches of training the neural machine translation model based on source-target text translation pairs.

4. The method of claim 1, wherein a special contrastive loss token is appended to the first sequence of tokens when it is input to the encoder of the neural machine translation model to obtain the first sentence representation.

5. The method of claim 1, wherein determining the contrastive loss function comprises:
determining a distance between the first sentence representation and the second sentence representation.

6. The method of claim 1, wherein determining the contrastive loss function comprises:
determining a distance between the first sentence representation and a negative example that is constructed from other noisy and clean sentences in a batch of speech signal training data.

7. The method of claim 1, wherein determining the contrastive loss function comprises:
determining a distance between the second sentence representation and a negative example that is constructed from other noisy and clean sentences in a batch of speech signal training data.

8. A system comprising:
a processor, and
a memory, wherein the memory stores instructions executable by the processor to:
input a speech signal to an automatic speech recognition model to obtain a transcript hypothesis including a first sequence of tokens, wherein the speech signal is associated with a golden transcript including a second sequence of tokens;
input the first sequence of tokens to an encoder of a neural machine translation model to obtain a first sentence representation;
input the second sequence of tokens to the encoder of the neural machine translation model to obtain a second sentence representation;
determine a contrastive loss function based on the first sentence representation and the second sentence representation; and
train the encoder of the neural machine translation model based on the contrastive loss function.

9. The system of claim 8, wherein the memory stores instructions executable by the processor to:
train the neural machine translation model based on source-target text translation pairs.

10. The system of claim 8 wherein the memory stores instructions executable by the processor to:
iteratively switch between batches of training the encoder of the neural machine translation model based on transcript hypotheses from the automatic speech recognition model and corresponding golden transcripts using the contrastive loss function, and batches of training the neural machine translation model based on source-target text translation pairs.

11. The system of claim 8, wherein a special contrastive loss token is appended to the first sequence of tokens when it is input to the encoder of the neural machine translation model to obtain the first sentence representation.

12. The system of claim 8 wherein the memory stores instructions executable by the processor to:
determine a distance between the first sentence representation and the second sentence representation.

13. The system of claim 8 wherein the memory stores instructions executable by the processor to:
determine a distance between the first sentence representation and a negative example that is constructed from other noisy and clean sentences in a batch of speech signal training data.

14. The system of claim 8 wherein the memory stores instructions executable by the processor to:
determine a distance between the second sentence representation and a negative example that is constructed from other noisy and clean sentences in a batch of speech signal training data.

15. A non-transitory computer-readable storage medium, comprising executable instructions that, when executed by a processor, facilitate performance of operations, comprising:
inputting a speech signal to an automatic speech recognition model to obtain a transcript hypothesis including a first sequence of tokens, wherein the speech signal is associated with a golden transcript including a second sequence of tokens;
inputting the first sequence of tokens to an encoder of a neural machine translation model to obtain a first sentence representation;
inputting the second sequence of tokens to the encoder of the neural machine translation model to obtain a second sentence representation;
determining a contrastive loss function based on the first sentence representation and the second sentence representation; and
training the encoder of the neural machine translation model based on the contrastive loss function.

16. The non-transitory computer-readable storage medium of claim 15, comprising executable instructions that, when executed by a processor, facilitate performance of operations, comprising:
training the neural machine translation model based on source-target text translation pairs.

17. The non-transitory computer-readable storage medium of claim 15, comprising executable instructions that, when executed by a processor, facilitate performance of operations, comprising:
iteratively switching between batches of training the encoder of the neural machine translation model based on transcript hypotheses from the automatic speech recognition model and corresponding golden transcripts using the contrastive loss function, and batches of training the neural machine translation model based on source-target text translation pairs.

18. The non-transitory computer-readable storage medium of claim 15, wherein a special contrastive loss token is appended to the first sequence of tokens when it is input to the encoder of the neural machine translation model to obtain the first sentence representation.

19. The non-transitory computer-readable storage medium of claim 15, wherein determining the contrastive loss function comprises:
determining a distance between the first sentence representation and a negative example that is constructed from other noisy and clean sentences in a batch of speech signal training data.

20. The non-transitory computer-readable storage medium of claim 15, wherein determining the contrastive loss function comprises:
determining a distance between the second sentence representation and a negative example that is constructed from other noisy and clean sentences in a batch of speech signal training data.
